(19) United States
(12) Patent Application Publication
(10) Pub. No.: US 2018/0308332 A1
(43) Pub. Date: Oct. 25, 2018

(54) SECURITY SYSTEM TO CAUSE FLASH BLINDNESS TO AN INTRUDER

(71) Applicant: Toni Bill Handley, Midland, TX (US)

(72) Inventor: Toni Bill Handley, Midland, TX (US)

(21) Appl. No.: 15/495,515

(22) Filed: Apr. 24, 2017

(51) Int. Cl. G08B 15/00; H05B 37/02; F21S 8/00; F21V 7/00

(52) U.S. Cl. CPC G08B 15/00; F21V 7/0025; F21S 8/036; H05B 37/0272

(57) ABSTRACT

A security system can cause flash blindness to an intruder by projecting high intensity light into intruder's eyes is disclosed. The security system includes a light blast housing enclosing a light on a front side to face a light opening, a plurality of reflectors positioned peripherally around the light, a remote receiver connected to the light on a first side, to an antenna on a second side and to a battery on a third side via a plurality of wires. The light blast housing is further attached to a bracket for mounting the security system to a wall. When a home owner detects the intruder, turns on the security system using a remote that is communicatively coupled to the remote receiver. Once high intensity light, emanated from the light and concentrated by the reflectors, is projected into intruder's eyes causes flash blindness and immobilizes the intruder.

### BACKGROUND

The embodiments herein relate generally to a device to cause flash blindness to an intruder by projecting high intensity light into intruder's eyes. Thus, a home owner can use the device to immobilize the intruder and use the device for personal safely.

### SUMMARY

A device to cause flash blindness to an intruder by projecting high intensity light into intruder's eyes is disclosed. The device includes a light blast housing enclosing a light on a front side to face a light opening, a plurality of reflectors positioned peripherally around the light, a remote receiver connected to the light on a first side, to an antenna on a second side and to a battery on a third side via a plurality of wires. The light blast housing is further attached to a bracket for mounting the device to a wall. When a home owner detects the intruder, turns on the device using a remote that is communicatively coupled to the remote receiver. Once high intensity light, emanated from the light and concentrated by the reflectors, is projected into intruder's eyes causes flash blindness and immobilizes the intruder.

### BRIEF DESCRIPTION OF THE FIGURES

The detailed description of some embodiments of the invention is made below with reference to the accompanying figures, wherein like numerals represent corresponding parts of the figures.

FIG. 1 shows a top view of one embodiment of the present invention shown in use;

FIG. 2 shows a perspective view of one embodiment of the present invention;

FIG. 3 shows a section view of one embodiment of the present invention taken from 3-3 in FIG. 1;

FIG. 4 shows a top view of one embodiment of the present invention illustrating the light blast housing;

FIG. 5 shows a top view of one embodiment of the present invention illustrating the light blast housing angled.

### DETAILED DESCRIPTION OF CERTAIN EMBODIMENTS

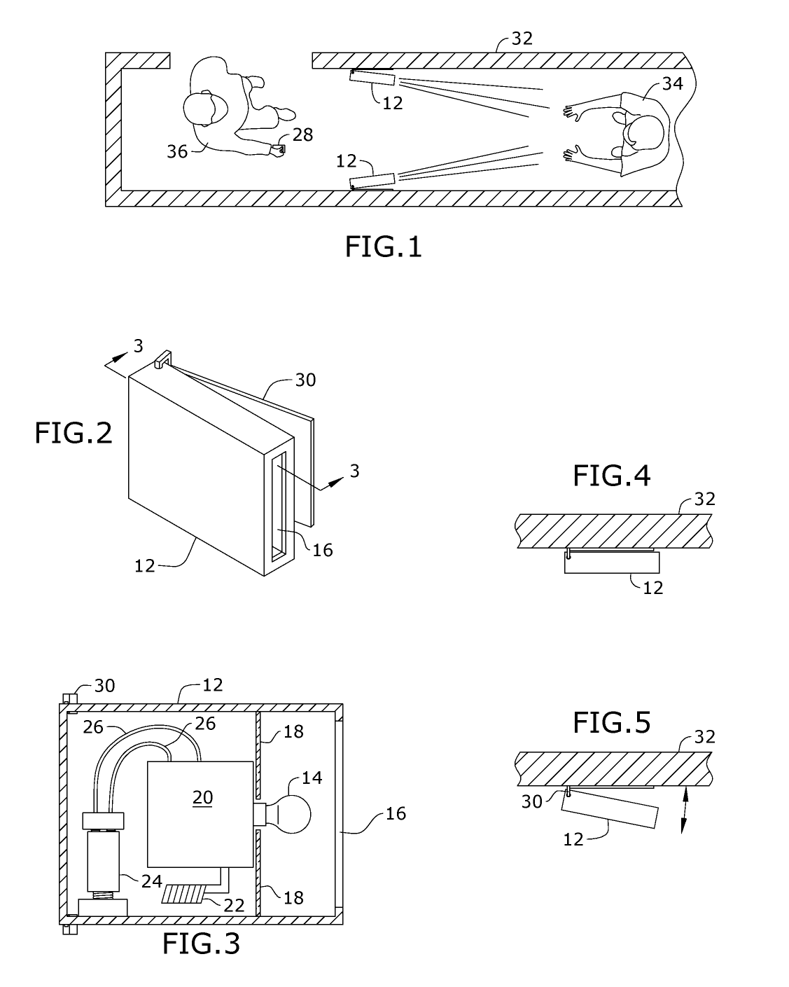

By way of example, and referring to FIGS. 1-5, one embodiment of the present device 10 comprises a light blast housing 12. The light blast housing encloses a light 14 on a front side to face a light opening 16, a plurality of reflectors 18 positioned peripherally around the light, a remote receiver 20 connected to the light on a first side, to an antenna 22 on a second side and to a battery 24 on a third side via a plurality of wires 26. Further, a remote 28 is communicatively coupled to the remote receiver located in the light blast housing. Furthermore, a bracket 30 is attached to an inner side of the light blast housing and configured to attach the light blast housing to a wall 32 so that high intensity light projects into intruder's eyes. Upon detecting an intruder 34, a home owner 36 turns on the device using the remote that in turn projects high intensity light, emanated from the light and concentrated by the reflectors, into intruder's eyes, in turn, causing flash blindness and immobilizes the intruder. The device is configured to emit high intensity light in a one second interval.

The device can be mounted at an angle to configure the device to project high intensity light into intruder's eyes. The battery is a nine volt battery. The remote can be configured to communicatively connect to a plurality of devices for synchronizing all the devices using the remote. Further, a vibration alert pad may be coupled to the device and the remote for alerting other members of the intruder.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, 116.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A security system to cause flash blindness to an intruder by projecting high intensity light into intruder's eyes, the security system further comprising:
an enclosed space bound by a first wall that is approximately parallel to a second wall;
a first light blast housing, enclosed a first light on a first front side to face a first light opening, a first plurality of reflectors positioned peripherally around the first light, a first remote receiver connected to the first light on a first light blast housing first side, to a first antenna on a first light blast housing second side and to a first battery on a first light blast housing third side via a first plurality of wires;
a first bracket, attached to a first inner side of the first light blast housing and attached to the first wall;
a second light blast housing, enclosed a second light on a second front side to face a second light opening, a second plurality of reflectors positioned peripherally around the second light, a second remote receiver connected to the second light on a second light blast housing second side, to a second antenna on a second light blast housing second side and to a second battery on a second light blast housing third side via a second plurality of wires;
a second bracket, attached to a second inner side of the second light blast housing and attached to the second wall; wherein the first bracket is approximately parallel to the second bracket;
a remote, communicatively coupled to the first remote receiver located in the first light blast housing and the second remote receiver located in the second light blast housing
wherein engaging the security system with the remote causes a first projection of a first high intensity light to be emanated from the first light that is further concentrated by the first plurality of reflectors, while causing a second projection of a second high intensity light to be emanated from the second light that is further concentrated by the second plurality of reflectors, into the eyes of the intruder causing the flash blindness and immobilizes the intruder.

2. The security system of claim 1, wherein the light is configured to emit high intensity light in a one second interval.
